(19) United States
(12) Patent Application Publication
(10) Pub. No.: US 2024/0096253 A1
(43) Pub. Date: Mar. 21, 2024

(54) SIGNAL TRANSMISSION METHOD AND APPARATUS, AND DISPLAY DEVICE

(71) Applicant: NOVATEK MICROELECTRONICS CORP., Taiwan (CN)

(72) Inventors: Chien Hao Li, Taiwan (CN); Jen-Chieh Hu, Taiwan (CN); Syang-Yun Tzeng, Taiwan (CN)

(21) Appl. No.: 18/233,006

(22) Filed: Aug. 11, 2023

Related U.S. Application Data
(60) Provisional application No. 63/408,825, filed on Sep. 21, 2022.

(51) Int. Cl. G09G 3/20

(52) U.S. Cl. CPC G09G 3/20; G09G 2310/08; G09G 2320/02; G09G 2330/06; G09G 2370/08

(57) ABSTRACT

The embodiments of the present disclosure provide a signal transmission method and apparatus for a display device, and a display device. The method includes: adjusting a data rate for signal transmission within a blanking time; and performing signal transmission within an active time by using the data rate adjusted within the blanking time; wherein a signal transmission period of the display device includes the blanking time and the active time. Through the method of the present disclosure, the range of data rate used for signal transmission could be significantly expanded, more abundant data rate transmission requirements could be met, Electro Magnetic Interference during signal transmission could be reduced, and the quality of pictures displayed on the display device could be guaranteed.

### TECHNICAL FIELD

The present disclosure relates to the field of signal processing, and more particularly, to a signal transmission method and apparatus, and a display device.

### BACKGROUND

Nowadays, the electronic industry is developing rapidly, and various electronic products such as mobile phones, computers and game consoles have become an indispensable part of people's life. In order to meet the more abundant use requirements, the functions of electronic products are becoming more and more powerful, and their internal circuits are becoming more and more complicated. Therefore, Electro Magnetic Interference (EMI), information transmission performance improvement and other issues have also become the key consideration in electronic product research and development.

Electro Magnetic Interference refers to the influence of the circuit system on the peripheral circuit system through conduction or radiation. EMI will reduce the performance of the circuit, and it may lead to the failure of the entire device in serious cases. With the development of technology, high resolution picture and high picture update rate are inevitable trends of display devices in the future. However, with the improvement of resolution and picture update rate, the amount of data transmission becomes quite huge. In order to adapt to this trend, it is necessary to increase the frequency and energy of signals for data transmission. When the frequency and energy of signals for data transmission are increased, it will produce serious electromagnetic radiation interference effect. Therefore, how to reduce the electromagnetic radiation interference effect of electronic display device and also ensure the high-quality transmission of display picture so as to meet the increasingly abundant display requirements is an urgent problem to be solved at present.

### SUMMARY

In order to solve the above problems, the present disclosure provides a signal transmission method for a display device, comprising: adjusting a data rate for signal transmission within a blanking time; and performing signal transmission within an active time by using the data rate adjusted within the blanking time; wherein a signal transmission period of the display device includes the blanking time and the active time.

According to the embodiments of the present disclosure, the signal transmission period is a frame period, the blanking time is a vertical blanking time, adjusting a data rate for signal transmission within a blanking time comprises: adjusting a data rate for signal transmission within the vertical blanking time, wherein the adjusted data rate is used for performing signal transmission within at least one frame after the vertical blanking time or used for performing signal transmission within at least one line after the vertical blanking time.

According to the embodiments of the present disclosure, the signal transmission period is a line period, the blanking time is a horizontal blanking time, and adjusting a data rate for signal transmission within a blanking time comprises: adjusting a data rate for signal transmission within the horizontal blanking time, wherein the adjusted data rate is used for performing signal transmission within at least one line after the horizontal blanking time.

According to the embodiments of the present disclosure, the line period has a preset time length, and a length of the active time is associated with the adjusted data rate; and a length of the horizontal blanking time is determined by the line period and the length of the active time.

According to the embodiments of the present disclosure, the signal transmission method further comprising: taking a first number of signal transmission periods as an adjustment cycle period, adjusting the data rate used for signal transmission, such that the data rate changes periodically within the adjustment cycle period, taking a second number of signal transmission periods as a maintaining time, and performing signal transmission at the same data rate within the maintaining time, wherein the first number and the second number are integers, and the first number is greater than the second number.

According to the embodiments of the present disclosure, an amount of data rate change within the adjustment cycle period is less than or equal to a first threshold, and an amount of data rate change between two adjacent data rates is less than or equal to a second threshold, wherein the first threshold is greater than or equal to the second threshold.

According to the embodiments of the present disclosure, the first threshold is 25% of a reference data rate, and the second threshold is 5% of the reference data rate.

According to the embodiments of the present disclosure, for a plurality of consecutive signal transmission periods of the display device, randomly determining at least one signal transmission period for adjusting the data rate for signal transmission,

According to the embodiments of the present disclosure, the data rate changes periodically within the adjustment cycle period comprises: the data rate monotonically increases in a first part of the adjustment cycle period, and the data rate monotonically decreases in a second part of the adjustment cycle period, wherein the data rate is lower than a maximum allowable data rate at a receiving end for signal transmission.

According to the embodiments of the present disclosure, the data rate monotonically increases in a first part of the adjustment cycle period comprises: the data rate monotonically increases at a first step size, and the data rate monotonically decreases in a second part of the adjustment cycle period comprises: the data rate monotonically decreases at a second step size, wherein the first step size is the same as or different from the second step size.

According to the embodiments of the present disclosure, for each signal transmission period of the display device, randomly determining whether to adjust the data rate for signal transmission.

According to the embodiments of the present disclosure, for each signal transmission period of the display device, in a case where it is determined that the data rate for signal transmission needs to be adjusted, determining the adjusted data rate base on a current data rate according to a predetermined adjustment rule; or determining the adjusted data rate randomly.

According to the embodiments of the present disclosure, the signal transmission method is used for a display device based on a point-to-point transmission architecture.

The embodiments of the present disclosure further provide a signal transmission apparatus for a display device, comprising: a rate adjustment circuit configured to adjust a data rate for signal transmission within a blanking time; a signal transmission circuit configured to perform signal transmission within an active time by using the data rate adjusted within the blanking time; wherein the signal transmission period of the display device includes the blanking time and the active time.

The embodiments of the present disclosure further provide a display device that transmits a display signal by any of the signal transmission methods described above.

The embodiments of the present disclosure provide a signal transmission method and apparatus, and a display device. Since the present disclosure adjusts the data rate for signal transmission within the blanking time and performs signal transmission within the active time by using the data rate adjusted within the blanking time, it not only reduces the Electro Magnetic Interference during signal transmission, but also prevents frequency variations from affecting the quality of the picture displayed by the display device, thus improving the overall performance of the display device. Furthermore, since the data rate used for signal transmission is adjusted within the blanking time, it is possible to significantly expand the range of data rate used for signal transmission, so as to meet more abundant data rate transmission requirements. This also allows for a more even distribution of electromagnetic radiation energy across a wider bandwidth frequency range, further enhancing the effectiveness of reducing electromagnetic interference during signal transmission.

### BRIEF DESCRIPTION OF THE DRAWINGS

In order to explain the technical solutions of the embodiments of the present disclosure more clearly, the drawings needed in the description of the embodiments will be briefly introduced below. Obviously, the drawings in the following description are only some exemplary embodiments of the present disclosure. For those of ordinary skill in the art, other drawings may be obtained according to these drawings without any creative effort.

Herein, in the drawings:

FIG. 1A is a schematic diagram illustrating a point-to-point transmission architecture according to embodiments of the present disclosure;

FIGS. 1B to 1C are schematic diagrams illustrating a display signal in the case of spread spectrum with a UI (Unit interval) as a basic unit of jitter according to embodiments of the present disclosure;

FIGS. 2A to 2B are schematic diagrams illustrating data rate variation within a signal transmission period according to embodiments of the present disclosure;

FIG. 3 is a schematic diagram illustrating a data rate adjustment process based on a frame period according to embodiments of the present disclosure;

FIGS. 4A to 4B are schematic diagrams illustrating a data rate adjusted based on a line period according to embodiments of the present disclosure;

FIG. 5 is a schematic diagram illustrating a signal frequency spectrum for the embodiment illustrated in FIGS. 4A to 4B;

FIGS. 6A to 6B are schematic diagrams illustrating a data rate adjusted based on a line period according to embodiments of the present disclosure;

FIGS. 7A to 7B are another schematic diagram illustrating a data rate adjusted based on a line period according to embodiments of the present disclosure;

FIGS. 8A to 8B are yet another schematic diagram illustrating a data rate adjusted based on a line period according to embodiments of the present disclosure;

FIG. 9 is a schematic flowchart illustrating a signal transmission method for a display device according to embodiments of the present disclosure;

FIG. 10 is a schematic diagram illustrating the composition of a signal transmission apparatus for a display device according to embodiments of the present disclosure; and

FIG. 11 is a schematic diagram illustrating a mini low voltage differential signal (Mini-LVDS) transmission architecture according to embodiments of the present disclosure.

### DETAILED DESCRIPTION OF THE EMBODIMENTS

In order to make the objectives, technical solutions and advantages of the present application more apparent, the exemplary embodiments according to the present disclosure will be described in detail below with reference to the drawings. Obviously, the described embodiments are only a part of the embodiments of the present application, rather than all the embodiments of the present application, and it should be understood that the present application is not limited by the exemplary embodiments described herein.

Furthermore, in the specification and the drawings, steps and elements that are substantially the same or similar are denoted by the same or similar reference signs, and repeated descriptions of these steps and elements will be omitted.

Furthermore, in the specification and the drawings, elements are described in singular or plural forms according to the embodiments. However, the singular and plural forms are appropriately selected for the proposed situations only for convenience of explanation, not intended to limit the present disclosure thereto. Therefore, singular forms may include plural forms, and plural forms may also include singular forms, unless the context clearly indicates otherwise.

Furthermore, in the specification and the drawings, the involved terms “first/second” are only used to distinguish similar objects, and do not represent a specific order of objects. Understandably, “first/second” may be interchanged in a specific order or sequence when allowed, so that the embodiments of the present disclosure described here may be implemented in an order other than those illustrated or described herein.

Furthermore, in the specification and the drawings, the adopted terms such as “upper”, “lower”, “vertical” and “horizontal”, etc. which relate to orientation or positional relationship are used only for describing the embodiments conveniently according to the present disclosure, and are not intended to limit the present disclosure thereto. Therefore, they should not be construed as a limitation to the present disclosure.

Furthermore, in the specification and the drawings, unless otherwise specified, “connection” does not necessarily mean “direct connection” or “direct contact”. Here, “connection” may mean both the function of fixation and electrical communication.

In order to facilitate the description of the present disclosure, the concepts related to the present disclosure are introduced below.

Electro Magnetic Radiation widely exists in the use process of various electronic products. With the increasingly powerful functions and faster operation speed of electronic products, Electro Magnetic Interference has become a key consideration in the design of electronic products. The methods to reduce Electro Magnetic Interference mainly include: reducing the energy of electromagnetic signal transmitting end, Spread Spectrum clocking (SSC) and so on. Among them, the Spread Spectrum clocking makes the frequency of high-speed clock jitter continuously in a certain range along with time, such that the energy of electromagnetic radiation in the frequency domain is evenly distributed in a certain bandwidth frequency range, thus a peak value and an average value of electromagnetic radiation energy decrease accordingly.

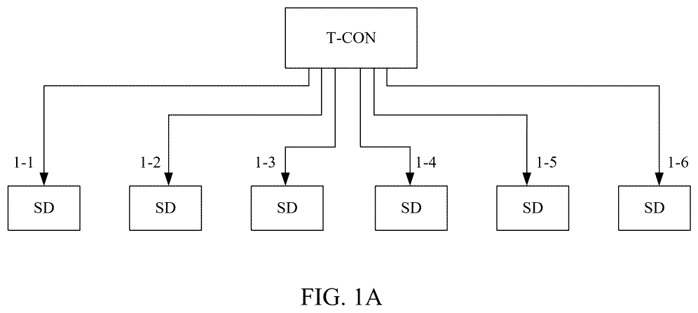

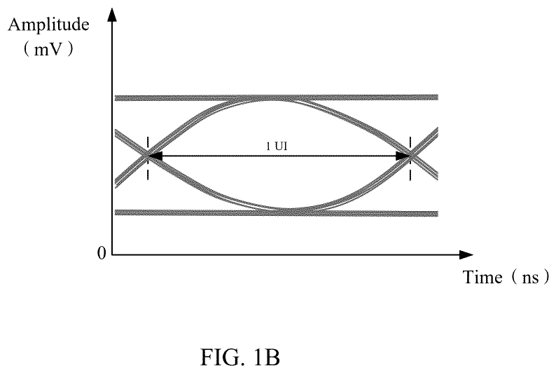

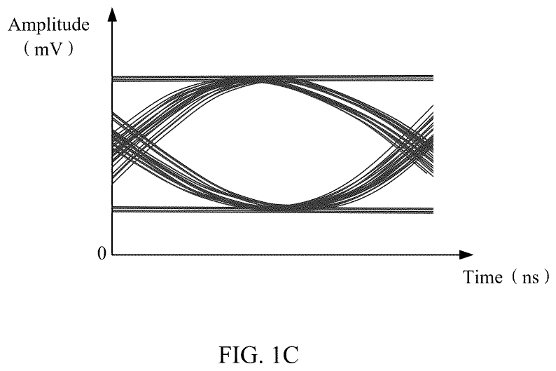

FIG. 1A is a schematic diagram illustrating a point-to-point transmission architecture according to embodiments of the present disclosure. As shown in FIG. 1A, a timing controller (T-CON) is an integrated circuit chip of the display device, and is used to send display-related signals to a plurality of source drivers (SD) to drive a plurality of pixels on the display screen to display. Display-related signals include a clock signal and a data signal, where the clock signal is used to control the transmission rate of data and the data signal is used to transmit RGB (Red Green Blue) data to be displayed. For the point-to-point transmission architecture, the clock signal and the data signal share one signal transmission path. That is, in FIG. 1A, each transmission line (for example, transmission line 1-1, 1-2, 1-3, 1-4, 1-5 and 1-6 in FIG. 1A) between T-CON and SD transmits both the clock signal and the data signal. The data signal may be transmitted within the active time, and the clock signal may be transmitted within the blanking time.

At present, for a display device based on a point-to-point transmission architecture, the spread spectrum of display signal (that is, the data signal) between T-CON and SD is all taking Unit Interval (UI) as the basic unit of frequency jitter (that is, the frequency of the display signal changes in each UI, regardless of the active time and the blanking time). Although it could effectively reduce Electro Magnetic Interference, it will also increase the total jitter (TJ), which increases the difficulty of processing the display signal of the display device.

Specifically, for the spread spectrum method with UI as the basic unit for frequency jitter, the data rate for signal transmission will be constantly changed with UI as the basic unit in the whole signal transmission process. Therefore, although this method could avoid the accumulation of electromagnetic radiation energy at a fixed frequency, such that the electromagnetic radiation energy in the frequency domain is evenly distributed in a certain bandwidth frequency range, thus reducing a peak value and an average value of electromagnetic radiation energy, it would introduce more jitter to the display signal within the active time of display signal transmission. Accordingly, this spread spectrum method reduces the accuracy of the display signal and increases the processing difficulty of the display signal. Moreover, in order to avoid the situation where the frequency jitter affects the display signal too much and thus hinders the normal transmission and processing of the display signal, the amplitude of the data rate change brought by spread spectrum usually cannot exceed 3% of the transmission data rate of the display signal. Due to the small variation in data rate caused by this spread spectrum method, the waveforms in various states of the display signal (for example, it may include eight states of 000, 001, 010, 011, 100, 101, 110 and 111) could be repeatedly superimposed by an oscilloscope to form an eye diagram corresponding to the display signal. Assuming that the eye diagram corresponding to the display signal when spread spectrum is not performed is as shown in FIG. 1B, then the eye diagram corresponding to the display signal when spread spectrum is performed is as shown in FIG. 1C, where the vertical axis represents the amplitude of the display signal (unit: mV) and the horizontal axis represents the time (unit: ns) in FIG. 1B and FIG. 1C. By comparing FIG. 1B and FIG. 1C, it could be seen that the jitter of the eye diagram is greater in the case where spread spectrum is performed.

Therefore, the present disclosure provides a signal transmission method for a display device, which could effectively reduce Electro Magnetic Interference of the display device without introducing disturbance to the display signal of the display device.

As an example, the present disclosure relates to the technology for reducing Electro Magnetic Interference of the display device, and embodiments of the present disclosure will be further described below with reference to the drawings.

Generally, for a display device based on a point-to-point transmission architecture, the signal transmission period of the display device includes a blanking time and an active time.

More specifically, in the scanning process where the display device converts the electrical signal into the optical signal, for example, the scanning may start from the upper left corner of the display screen and move horizontally to the right, and when the scanning point moves to the rightmost side of the display screen, the scanning point quickly returns to the leftmost side and starts scanning the next line again. The time between the scanning point moving from the rightmost side of the N-th line to the leftmost side of the (N+1)-th line is called the horizontal blanking (H-Blank) time, where N is a positive integer. The scanning point returns to the upper left corner of the display screen after scanning of all the lines (i.e., scanning point reaches the bottom right corner of the display screen), to prepare for the next scanning (that is, the next frame). The time between the scanning point moving from the bottom right corner of the display screen to the upper left corner of the display screen is called the vertical blanking (V-Blank) time.

It could be seen that the display signal of the display device is actually transmitted only within the active time, and the blanking time is used to prepare for transmission of the display signal. Therefore, the present disclosure provides a signal transmission method for a display device, including: adjusting a data rate for signal transmission within a blanking time; and performing signal transmission within an active time by using the data rate adjusted within the blanking time. Because the adjusted data rate is used for signal transmission within the active time (that is, the data rate used for signal transmission is not adjusted within the active time), the jitter of display signal transmission could be reduced and the transmission quality of display signal could be improved.

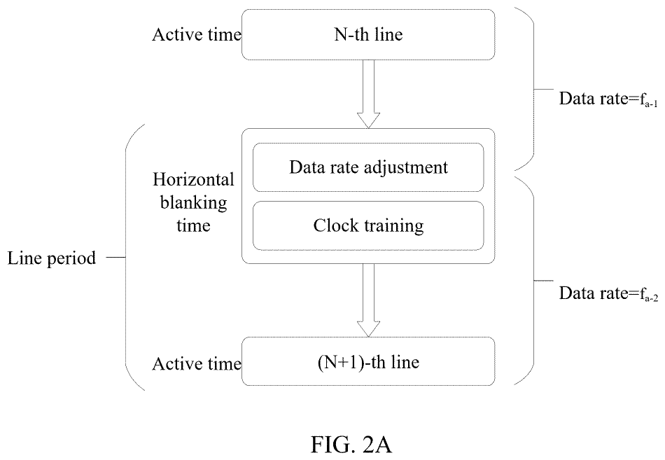

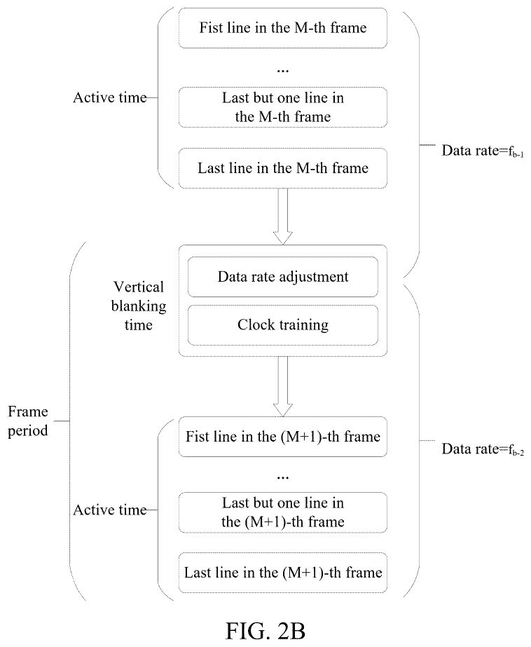

Taking a line period as the signal transmission period and a horizontal blanking time as the blanking time, FIG. 2A is a schematic diagram illustrating data rate variation within a line period according to embodiments of the present disclosure.

In FIG. 2A, the line period may include an active time and a horizontal blanking time, where the display device transmits a display signal for the line within the active time, and operations such as data rate adjustment, clock training may be performed within the horizontal blanking time. Therefore, assuming that the data rate for display signal transmission may be fₐ₋₁ for the N-th line, then after data rate is adjusted within the horizontal blanking time, the data rate for display signal transmission may be fₐ₋₂ for the (N+1)-th line, wherein N is a positive integer. The data rate fₐ₋₂ may be different from the data rate fₐ₋₁. Optionally, after the data rate for display signal transmission is adjusted within the horizontal blanking time, the adjusted data rate may be used for signal transmission within one line after the horizontal blanking time, and the adjusted data rate may also be used for signal transmission within a plurality of lines after the horizontal blanking time.

Similarly, taking a frame period as the signal transmission period and a vertical blanking time as the blanking time, FIG. 2B is a schematic diagram illustrating data rate variation within a frame period according to embodiments of the present disclosure.

In FIG. 2B, the frame period may include an active time and a vertical blanking time, where the display device transmits a display signal for a frame (including a plurality of lines), and operations such as data rate adjustment and clock training may be performed within the vertical blanking time. Therefore, assuming that the data rate for display signal transmission may be f_{b-1} for the last line of the M-th frame, then after data rate is adjusted within the vertical blanking time, the data rate for display signal transmission may be f_{b-2} for the first line of the (M+1)-th frame, wherein M is a positive integer. The data rate f_{b-2} may be different from the data rate f_{b-1}. Optionally, after the data rate for display signal transmission is adjusted within the vertical blanking time, the adjusted data rate may be used for signal transmission within one frame after the vertical blanking time, and the adjusted data rate may also be used for signal transmission within a plurality of frames after the vertical blanking time.

It should be noted that the signal transmission method of the present disclosure could adjust the data rate for signal transmission only within the horizontal blanking time, could also adjust the data rate for signal transmission only within the vertical blanking time, and could also adjust the data rate for signal transmission within both the horizontal blanking time and the vertical blanking time.

Different from the spread spectrum method in which the UI is the basic unit of jitter, the signal transmission method in the embodiments shown in FIGS. 2A and 2B could adjust the data rate for signal transmission only within the blanking time and keep the data rate for signal transmission within the active time. Therefore, the change of data rate does not bring jitter to the display signal transmitted within the active time, which effectively ensures the transmission quality of the display signal. In addition, after the data rate has been adjusted for many times, the signal transmission method of the embodiment shown in FIGS. 2A and 2B could adjust the data rate for display signal transmission in a wider range, such that the energy of electromagnetic radiation in the frequency domain is evenly distributed across a wider bandwidth frequency range, thereby significantly reducing a peak value and an average value of electromagnetic radiation energy. The signal transmission method disclosed herein could be applied to any data transmission range that the receiving end capable of processing. For example, by using the signal transmission method of the present disclosure, the amplitude of the data rate change may reach 30% of the transmission data rate of the display signal.

It should be understood that for the signal transmission method for a display device of the present disclosure, the variation in data rate for signal transmission is high, thus the corresponding eye diagram cannot be obtained by repeatedly superimposing the waveforms in various states of the display signal, that is, the image shown in FIG. 1B or FIG. 1C cannot be obtained by oscilloscope analysis.

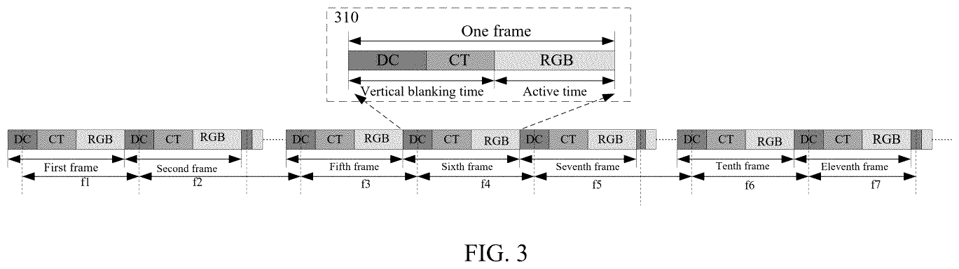

FIG. 3 is a schematic diagram illustrating a data rate adjustment process based on a frame period according to embodiments of the present disclosure.

As shown in FIG. 3, each frame period may have a structure shown at 310, that is, each frame period may include a vertical blanking time and an active time. The vertical blanking time may include a data rate adjustment time (as shown by DC (Data rate change) in FIG. 3) and a clock training time (as shown by CT (Clock Training) in FIG. 3). A signal for display could be transmitted within the active time, the signal may include RGB (Red Green Blue) data.

For a plurality of frames, the data rate for signal transmission may be adjusted within every frame period; optionally, the frame period may be selected at a fixed interval to adjust the data rate for signal transmission (for example, the data rate for signal transmission is adjusted every two frame periods); optionally, the frame period may be randomly selected to adjust the data rate for signal transmission; optionally, the frame period may be selected in real time according to other parameters of the circuit to adjust the data rate for signal transmission.

For example, in FIG. 3, from the first frame to the second frame, the data rate for signal transmission is changed from f1 to f2; from the second frame to the fifth frame, the data rate for signal transmission is changed from f2 to f3; from the fifth frame to the sixth frame, the data rate for signal transmission is changed from f3 to f4; from the sixth frame to the seventh frame, the data rate for signal transmission is changed from f4 to f5; from the seventh frame to the tenth frame, the data rate for signal transmission is changed from f5 to f6; and from the tenth frame to the eleventh frame, the data rate for signal transmission is changed from f6 to f7.

According to the embodiment of the present disclosure, for a plurality of frame periods, the data rate for signal transmission may also be adjusted periodically. For example, the data rate for signal transmission may be adjusted with a first number of frame periods as an adjustment cycle period, such that the data rate changes periodically within the adjustment cycle period, and a second number of frame periods is taken as a maintaining time, and signal transmission is performed at the same data rate within the maintaining time, where the first number and the second number are integers, and the first number is greater than the second number.

For example, the data rate for signal transmission may be adjusted with 11 frame periods (that is, the first number of frame periods) as the adjustment cycle period, such that the data rate changes periodically within the adjustment cycle period, and one or more (for example, 2, 3, 5, etc.) frame periods (that is, the second number of frame periods) may be taken as the maintaining time, and signal transmission is performed at the same data rate within the maintaining time, where the number of frame periods within the maintaining time is less than 11.

For another example, 24 frame periods (that is, the first number of frame periods) are taken as the adjustment cycle period, the data rate is adjusted once every 4 frame periods, that is, the maintaining time of each data rate is 4 frame periods (that is, the second number of frame periods). Specifically, the data rate of the first to fourth frame periods is f1, the data rate of the fifth to eighth frame periods is f2, the data rate of the ninth to twelfth frame periods is f3, the data rate of the thirteenth to sixteenth frame periods is f4, the data rate of the seventeenth to twentieth frames is f3, the data rate of the twenty-first to twenty-fourth frames is f2, and the data rate of the twenty-fifth to twenty-eighth frames becomes f1 again.

Optionally, for the frame period in which the data rate for signal transmission needs to be adjusted, the adjusted data rate may be determined based on a current data rate according to a predetermined adjustment rule (for example, monotonically increasing or decreasing a certain proportion). For example, the data rate may monotonically increase with a first step size in a first part of an adjustment cycle period and monotonically decrease with a second step size in a second part of the adjustment cycle period, the first step size may be the same as or different from the second step size.

In addition, for the frame period in which the data rate for signal transmission needs to be adjusted, the adjusted data rate may also be randomly determined.

It should be understood that, similar to the embodiment shown in FIG. 3, for a plurality of lines, it may also be determined that the data rate for signal transmission is adjusted within every line period; optionally, line period may be selected at a fixed interval to adjust the data rate for signal transmission (for example, the data rate for signal transmission is adjusted every two line periods); optionally, the line period may be randomly selected to adjust the data rate for signal transmission; optionally, the line period may be selected according to other parameters of the circuit to adjust the data rate for signal transmission.

In addition, for a plurality of line periods, the data rate for signal transmission may also be adjusted periodically. For example, the data rate for signal transmission may be adjusted with a third number of line periods as an adjustment cycle period, such that the data rate changes periodically within the adjustment cycle period, and a fourth number of line periods is taken as a maintaining time, and signal transmission is performed at the same data rate within the maintaining time, where the third number and the fourth number are integers, and the third number is greater than the fourth number.

Optionally, for the line period in which the data rate for signal transmission needs to be adjusted, the adjusted data rate may be determined based on a current data rate according to a predetermined adjustment rule (for example, monotonically increasing or decreasing by a certain proportion). For example, the data rate may monotonically increase with a first step size in a first part of an adjustment cycle period and monotonically decrease with a second step size in a second part of the adjustment cycle period, the first step size may be the same as or different from the second step size.

For example, 20 line periods (that is, the third number of line periods) may be used as the adjustment cycle period, and the data rate may be adjusted once every 5 line periods (that is, the fourth number of line periods), that is, the maintaining time of each data rate is 5 line periods. Specifically, the data rate of the first to fifth line periods is f1, the data rate of the sixth to tenth line periods is f2, and the data rate of the eleventh to fifteenth line periods is f3, the data rate of the sixteenth to twentieth line periods is f2, and then the data rate of the twenty-first to twenty-fifth frame periods becomes f1 again.

In addition, the adjusted data rate may also be determined randomly for the line period where the data rate for signal transmission needs to be adjusted.

According to the embodiment of the present disclosure, the time length of the frame period and/or the line period may be fixed. The length of the line active time is associated with the adjusted data rate. The length of the horizontal blanking time may be determined by the line period and the length of the active time. For example, horizontal blanking time=line period−line active time.

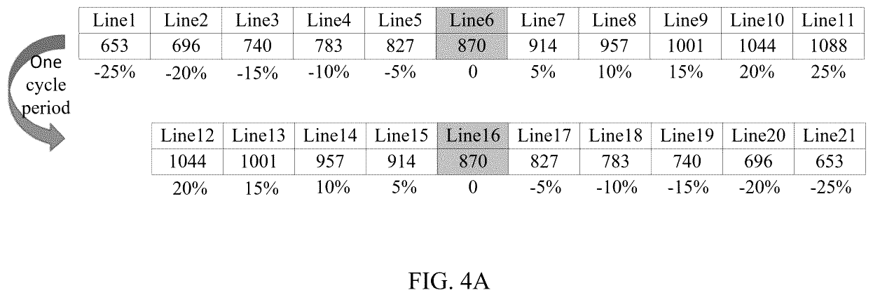

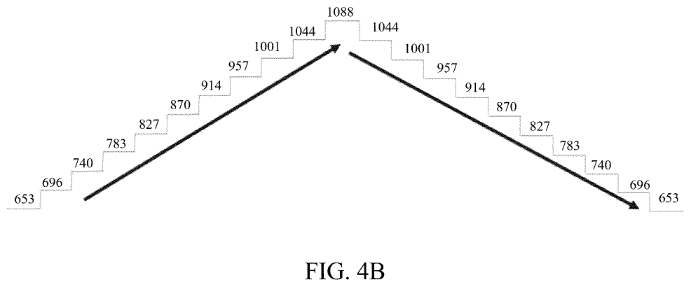

FIG. 4A is a schematic diagram illustrating a data rate adjusted based on a line period according to embodiments of the present disclosure.

In the example of FIG. 4A, the data rate for signal transmission is adjusted with 20 line periods (that is, the third number of line periods) as the adjustment cycle period and 1 line period (that is, the fourth number of line periods) as the maintaining time. Assuming that 870 Mbps is taken as a reference data rate, the data rate within the active time of the first line may be 653 Mbps (that is, 25% lower than the reference data rate 870 Mbps); the data rate within the active time of the second line may be 696 Mbps (that is, 20% lower than the reference data rate 870 Mbps); the data rate within the active time of the third line may be 740 Mbps (that is, 15% lower than the reference data rate 870 Mbps) . . . the data rate within the active time of the twentieth line may be 696 Mbps (that is, 20% lower than the reference data rate 870 Mbps); the data rate within the active time of the twenty-first line may be 653 Mbps (that is, 25% lower than the reference data rate 870 Mbps). It should be understood that the reference data rate could be the rated data rate for signal transmission, but it is not limited to this.

For the example shown in FIG. 4A, the data rate of each line period within the adjustment cycle period is shown in FIG. 4B. That is, the data rate monotonically increases in the first to eleventh lines of the adjustment cycle period and monotonically decreases in the twelfth to twenty-first lines of the adjustment cycle period. Wherein, the adjustment range of the data rate is ±25% within the data transmission range that the receiving end for signal transmission could process.

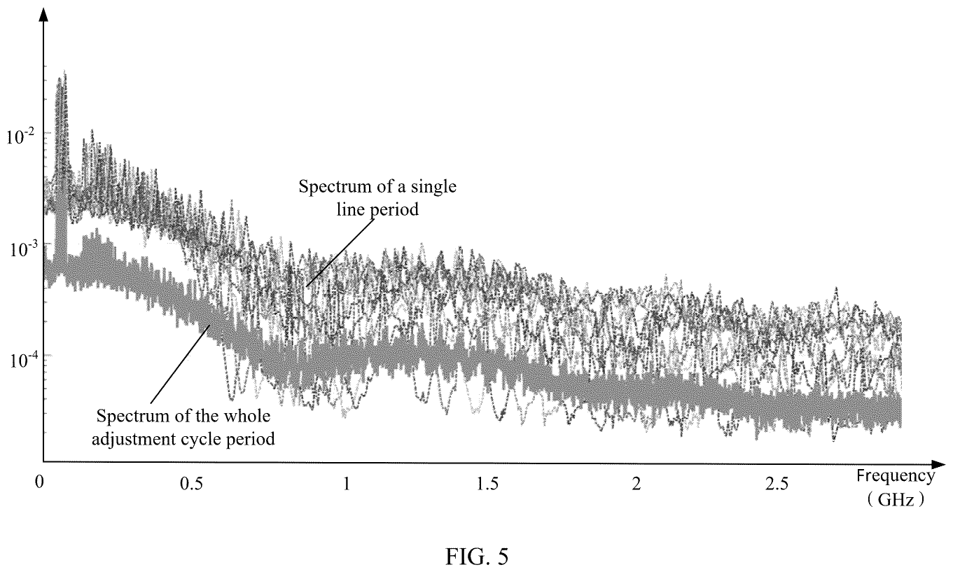

FIG. 5 is a schematic diagram illustrating a signal spectrum for the embodiment shown in FIGS. 4A to 4B.

As shown in FIG. 5, for the first to twenty-first lines (data rate changes between 653 Mbps to 1088 Mbps) in the embodiment shown in FIGS. 4A to 4B, the spectrum of a single line period is shown in the curves at the upper part in FIG. 5. The spectrum of the whole adjustment cycle period obtained by synthesizing results of the spectrum of respective line periods is shown in the gray thick curves at the lower part in FIG. 5. Thus, through the signal transmission method of the present disclosure, the electromagnetic radiation energy is significantly reduced compared to using single data rate for signal transmission.

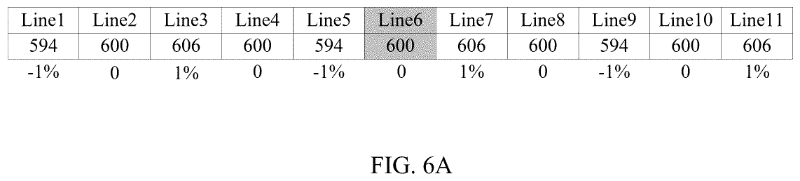

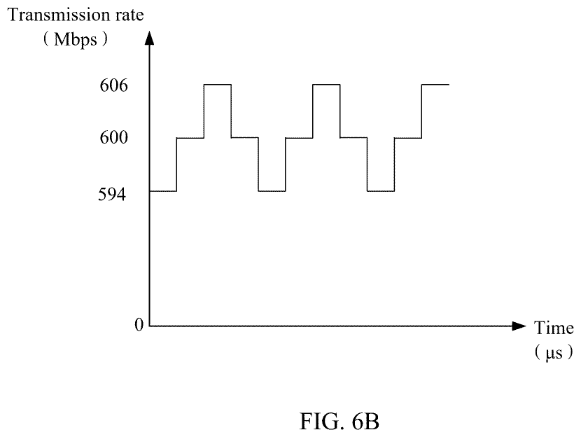

FIG. 6A is a schematic diagram illustrating a data rate adjusted based on a line period according to embodiments of the present disclosure.

In the example of FIG. 6A, the data rate for signal transmission is adjusted with 4 line periods as the adjustment cycle period and 1 line period as the maintaining time. Assuming that 600 Mbps is taken as the reference data rate, the data rate within the active time of the first line may be 594 Mbps (that is, 1% lower than the reference data rate 600 Mbps); the data rate within the active time of the second line may be 600 Mbps; the data rate within the active time of the third line may be 606 Mbps (that is, 1% higher than the reference data rate 600 Mbps); the data rate within the active time of the fourth line may be 600 Mbps, so the first to fourth lines may be regarded as one adjustment cycle period. By analogy, the fifth to eighth lines, the ninth to twelfth line, . . . , (4n-3)-th to the 4n-th lines may form adjustment cycle periods respectively, where n is an integer greater than or equal to 1.

For the example shown in FIG. 6A, the change of data rate within respective line periods is shown in FIG. 6B, where the vertical axis represents data rate (unit: Mbps) and the horizontal axis represents time (unit: μs) in FIG. 6B. That is, the data rate takes 4 line periods as the adjustment cycle period and 1 line period as the maintaining time, and changes regularly around the reference data rate based on the reference data rate 600 Mbps.

Similarly, according to the embodiment of the present disclosure, the data rate may also be adjusted based on the frame period as shown in FIGS. 6A and 6B.

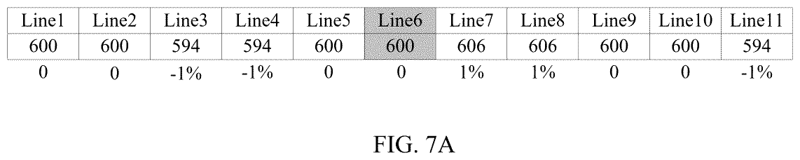

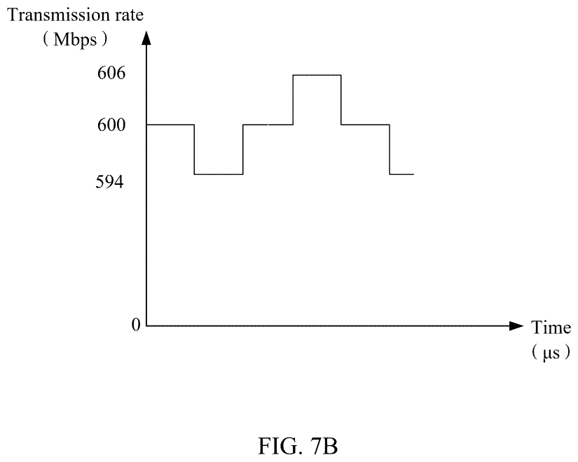

FIG. 7A is another schematic diagram illustrating a data rate adjusted based on a line period according to embodiments of the present disclosure.

In the example of FIG. 7A, the data rate for signal transmission is adjusted with 8 line periods as the adjustment cycle period and 2 line periods as the maintaining time. Assuming that 600 Mbps is taken as the reference data rate, the data rate within the active time of the first line and the second line may be 600 Mbps; the data rate within the active time of the third line and the fourth line may be 594 Mbps (that is, 1% lower than the reference data rate 600 Mbps); the data rate within the active time of the fifth line and the sixth line may be 600 Mbps; the data rate within the active time of the seventh line and the eighth line may be 606 Mbps (that is, 1% higher than the reference data rate 600 Mbps), so the first to eighth lines may be regarded as an adjustment cycle. By analogy, the ninth to sixteenth lines, the seventeenth to twenty-fourth lines . . . , (8n-7)-th to 8n-th lines may form adjustment cycle periods respectively, where n is an integer greater than or equal to 1.

For the example shown in FIG. 7A, the change of data rate within respective line periods is shown in FIG. 7B, where the vertical axis represents data rate (unit: Mbps) and the horizontal axis represents time (unit: μs) in FIG. 7B. That is, the data rate takes 8 line periods as the adjustment cycle period and 2 line periods as the maintaining time, and changes regularly around the reference data rate based on the reference data rate 600 Mbps.

Similarly, according to the embodiment of the present disclosure, the data rate may also be adjusted based on the frame period as shown in FIGS. 7A and 7B.

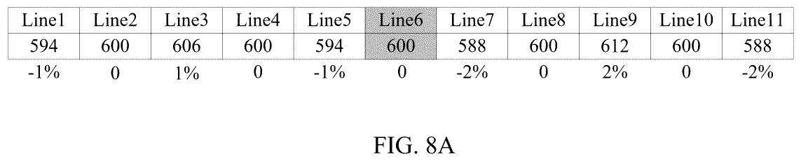

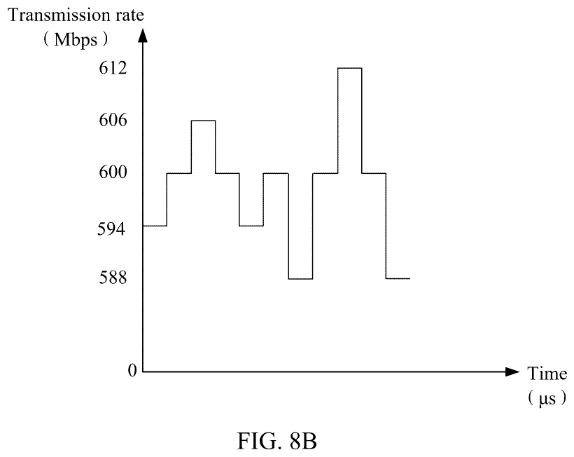

FIG. 8A is yet another schematic diagram illustrating a data rate adjusted based on a line period according to embodiments of the present disclosure.

In the example of FIG. 8A, the data rate for signal transmission is randomly adjusted. Assuming that 600 Mbps is taken as the reference data rate, the data rate within the active time of the first line may be 594 Mbps (that is, 1% lower than the reference data rate 600 Mbps); the data rate within the active time of the second line may be 600 Mbps; the data rate within the active time of the third line may be 606 Mbps (that is, 1% higher than the reference data rate 600 Mbps) . . . the data rate within the active time of the eleventh line may be 588 Mbps (that is, 2% lower than the reference data rate 600 Mbps), so the data rates of respective lines may not have a periodic cyclic pattern.

For the example shown in FIG. 8A, the change of data rate within respective line periods is shown in FIG. 8B, where the vertical axis represents the data rate (unit: Mbps) and the horizontal axis represents the time (unit: μs) in FIG. 8B. That is, the data rate changes randomly, wherein the adjustment range of the data rate is within the data transmission range that the receiving end for signal transmission could process. For example, a maximum data rate should be lower than a maximum allowable data rate of the receiving end for signal transmission, and a minimum data rate should ensure that the data transmission of the corresponding line could be completed within the active time of the line period.

Similarly, according to the embodiment of the present disclosure, the data rate may also be adjusted based on the frame period as shown in FIGS. 8A and 8B.

For the signal transmission method of the present disclosure, both the data rate within the line period and the data rate within the frame period could be changed randomly.

For example, assuming that the data rate within the active time of the N-th line is f, the data rate within the active time of the (N-a)-th line may be f±c %, and the data rate within the active time of the (N+b)-th line may be f±d %, where a, b are the number of lines differ from the N-th line, c, d are the variation amplitude of the data rate, and further, a, b may be the same or different values, c, d may be the same or different values.

For another example, assuming that the data rate within the active time of the M-th frame is f, the data rate within the active time of the (M-x)-th frame may be f±w %, and the data rate within the active time of the (M+y)-th frame may be f±z %, where x, y are the number of frames different from the M-th frame, w, z are the variation amplitude of the data rate, and further, x, y may be the same or different values, w, z may be the same or different values.

By randomly changing the data rate within the data transmission range that the receiving end could process, the signal transmission method of the present disclosure could be used in more abundant application scenarios, to meet more abundant data rate change requirements.

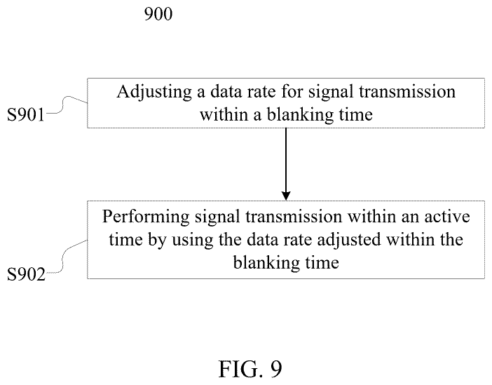

FIG. 9 is a schematic flowchart 900 illustrating a signal transmission method for a display device according to embodiments of the present disclosure.

In step S901, a data rate for signal transmission is adjusted within a blanking time; in step S902, signal transmission is performed within an active time by using the data rate adjusted within the blanking time, where a signal transmission period of the display device may include the blanking time and the active time.

According to embodiments of the present disclosure, the signal transmission period may be a frame period, the blanking time may be a vertical blanking time, and the data rate for signal transmission may be adjusted within the vertical blanking time, where the adjusted data rate is used for performing signal transmission within at least one frame after the vertical blanking time or used for performing signal transmission within at least one line after the vertical blanking time.

Optionally, a first number of frame periods may be taken as an adjustment cycle period, the data rate used for signal transmission is adjusted, such that the data rate changes periodically within the adjustment cycle period, a second number of frame periods is taken as a maintaining time, and signal transmission is performed at the same data rate within the maintaining time, where the first number and the second number are integers, and the first number is greater than the second number.

According to embodiments of the present disclosure, the signal transmission period may be a line period, the blanking time may be a horizontal blanking time, and the data rate for signal transmission may be adjusted within the horizontal blanking time, where the adjusted data rate is used for performing signal transmission within at least one line after the horizontal blanking time.

Optionally, a third number of line periods may be taken as an adjustment cycle period, the data rate used for signal transmission is adjusted, such that the data rate changes periodically within the adjustment cycle period, a fourth number of line periods is taken as a maintaining time, and signal transmission is performed at the same data rate within the maintaining time, where the third number and the fourth number are integers, and the third number is greater than the fourth number.

The line period may have a preset time length, and a length of the active time is associated with the adjusted data rate; and a length of the horizontal blanking time is determined by the line period and the length of the active time.

According to the embodiment of the present disclosure, an amount of data rate change within the adjustment cycle period is less than or equal to a first threshold, and an amount of data rate change between two adjacent data rates is less than or equal to a second threshold, wherein the first threshold is greater than or equal to the second threshold. For example, the first threshold may be 25% of a reference data rate, and the second threshold may be 5% of the reference data rate. The first threshold and the second threshold may be determined according to the actual demand or the performance of the display device hardware. According to the embodiment of the present disclosure, the first threshold and the second threshold may be determined by a maximum allowable data rate and a minimum allowable data rate of the display device hardware, where the maximum allowable data rate is determined by the data receiving/processing capability of the receiving end for signal transmission, and the minimum allowable data rate is determined by the length of the active time and the amount of data to be transmitted.

According to embodiments of the present disclosure, the data rate may monotonically increase in a first part of the adjustment cycle period and monotonically decrease in a second part of the adjustment cycle period, where the data rate is lower than a maximum allowable data rate at a receiving end for signal transmission.

In addition, both the moment for adjusting signal transmission and the data rate for signal transmission may be determined in a random manner. That is, for a plurality of consecutive signal transmission periods of the display device, at least one signal transmission period for adjusting the data rate for signal transmission may be randomly determined. And for each signal transmission period of the display device, it may be further randomly determined whether to adjust the data rate for signal transmission. It should be understood that the signal transmission period herein may be either a frame period or a line period.

For each signal transmission period of the display device, when it is determined that the data rate for signal transmission needs to be adjusted, the adjusted data rate is determined based on a current data rate according to a predetermined adjustment rule (for example, the adjusted data rate may be determined by multiplying the current data rate by a certain proportional coefficient, and the adjusted data rate may be determined by increasing or decreasing the current data rate by a certain value, etc.); or the adjusted data rate is randomly determined.

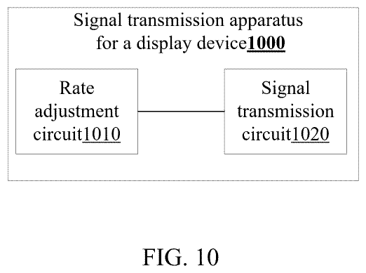

FIG. 10 is a schematic diagram illustrating the composition of a signal transmission apparatus 1000 for a display device according to embodiments of the present disclosure.

As shown in FIG. 10, a signal transmission apparatus 1000 for a display device may include a rate adjustment circuit 1010 configured to adjust a data rate for signal transmission within a blanking time; a signal transmission circuit 1020 configured to perform signal transmission within an active time by using the data rate adjusted within the blanking time; where the signal transmission period of the display device includes the blanking time and the active time. The rate adjustment circuit 1010 and the signal transmission circuit 1020 are electrically connected.

Optionally, the signal transmission period may be a frame period, and the blanking time may be a vertical blanking time. In this case, the rate adjustment circuit 1010 may be further configured to adjust the data rate for signal transmission within the vertical blanking time, where the adjusted data rate is used for performing signal transmission within at least one consecutive frame after the vertical blanking time or used for performing signal transmission within at least one consecutive line after the vertical blanking time.

Optionally, the signal transmission period may be a line period, and the blanking time may be a horizontal blanking time. In this case, the rate adjustment circuit 1010 may be further configured to adjust the data rate for signal transmission within the horizontal blanking time, where the adjusted data rate is used for performing signal transmission within at least one consecutive line after the horizontal blanking time.

According to the embodiment of the present disclosure, the rate adjustment circuit 1010 could either adjust the data rate for signal transmission periodically or adjust the data rate for signal transmission randomly.

For example, in the case where the rate adjustment circuit 1010 adjusts the data rate for signal transmission periodically, the data rate may monotonically increase in a first part of an adjustment cycle and monotonically decrease in a second part of the adjustment cycle, where the data rate is lower than a maximum allowable data rate of the receiving end for signal transmission. Optionally, the data rate may monotonically increases at a first step size, and monotonically decreases at a second step size, where the first step size is the same as or different from the second step size.

In the case where the rate adjustment circuit 1010 adjusts the data rate for signal transmission randomly, the rate adjustment circuit 1010 may be further configured to, for a plurality of consecutive signal transmission periods of the display device, randomly determine at least one signal transmission period for adjusting the data rate for signal transmission. In addition, the rate adjustment circuit 1010 may also be configured to, for each signal transmission period of the display device, randomly determine whether to adjust the data rate for signal transmission. Optionally, for each signal transmission period of the display device, when it is determined that the data rate for signal transmission needs to be adjusted, the adjusted data rate may be determined based on a current data rate according to a predetermined adjustment rule; or the adjusted data rate may be determined randomly.

Embodiments of the present disclosure further provide a display device, which may include the signal transmission apparatus in any of the embodiments described above, and transmit a display signal by the signal transmission method in any of the embodiments described above. Optionally, the display device of the present disclosure may include various devices including a display screen, such as mobile phones, computers, game consoles, projectors, etc. The display device of the present disclosure may be based on a point-to-point transmission architecture.

Therefore, the present disclosure provides a signal transmission method and apparatus for a display device, and a display device.

According to the embodiment of the present disclosure, the signal transmission method for a display device comprising: adjusting a data rate for signal transmission within a blanking time; and performing signal transmission within an active time by using the data rate adjusted within the blanking time; where a signal transmission period of the display device includes the blanking time and the active time.

Since the present disclosure adjusts the data rate for signal transmission within the blanking time and performs signal transmission within the active time by using the data rate adjusted within the blanking time, it not only reduces the Electro Magnetic Interference during signal transmission, but also prevents frequency variations from affecting the quality of the picture displayed by the display device, thus improving the overall performance of the display device. Furthermore, since the data rate used for signal transmission is adjusted within the blanking time, it is possible to significantly expand the range of data rate used for signal transmission, so as to meet more abundant data rate transmission requirements. This also allows for a more even distribution of electromagnetic radiation energy across a wider bandwidth frequency range, further enhancing the effectiveness of reducing electromagnetic interference during signal transmission.

It should be noted that, although the above embodiments of the present disclosure mainly take the display device based on a point-to-point transmission architecture as an example, the data rate adjustment manner of the present disclosure may also be applied to the display device with a Multi-drop transmission architecture (for example, the Mini-LVDS transmission architecture). That is, in the case of a display device with the Mini-LVDS transmission architecture, the data rate for signal transmission may also be adjusted in order to expand the range of data rate for signal transmission, such that the energy of electromagnetic radiation could be evenly distributed across a wider bandwidth frequency range, thus reducing Electro Magnetic Interference during signal transmission.

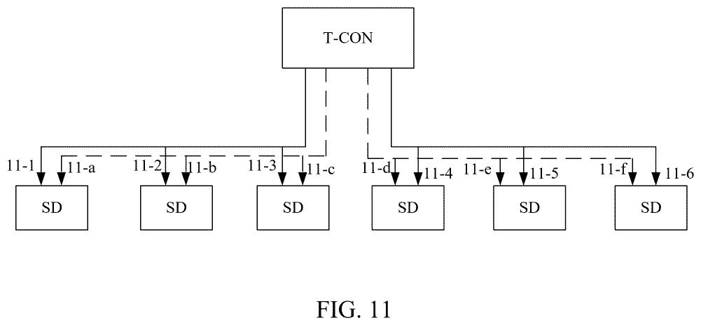

FIG. 11 is a schematic diagram illustrating a Mini-LVDS transmission architecture according to embodiments of the present disclosure. The timing controller (T-CON) is connected with a plurality of source drivers (SD) to drive a plurality of pixels on the display screen to display. Different from the point-to-point transmission architecture shown in FIG. 1A, for the Mini-LVDS transmission architecture, the clock signal and the data signal have their own separate transmission paths. For example, clock signals are transmitted on transmission lines 11-1, 11-2, 11-3, 11-4, 11-5 and 11-6 shown by solid lines in FIG. 11, and data signals are transmitted on transmission lines 11-a, 11-b, 11-c, 11-d, 11-e and 11-f shown by dashed lines in FIG. 11. For the Mini-LVDS transmission architecture, since the data signal and the clock signal are transmitted independently, there is no need to distinguish the active time and the blanking time for transmission, as long as the data signal and the clock signal are synchronously adjusted.

Therefore, under the Mini-LVDS transmission architecture, it is not necessary to adjust the data rate for signal transmission within the blanking time as that in the point-to-point architecture, and it could be still ensured that the variation of data rate will not affect the quality of the picture displayed by the display device. Optionally, the data rate for signal transmission may be adjusted by the following manners and any combinations thereof: adjusting the data rate for signal transmission in units of a frame period, adjusting the data rate for signal transmission in units of a line period, and adjusting the data rate for signal transmission in units of a unit interval (UI). In addition, the data rate for signal transmission may also be adjusted within a frame and/or within a line. Under the Mini-LVDS transmission architecture, by controlling the specifications of the respective eye diagrams (similar to that shown in FIG. 1B) of the clock signal and the data signal using the various data rate adjustment methods described above, the transmission quality of the data signal and the clock signal could be ensured without generating the big jitter shown in FIG. 1C.

The present disclosure uses specific words to describe the embodiments of the present disclosure. Examples such as “first/second embodiment”, “one embodiment” and/or “some embodiments” refer to a certain feature, structure or characteristic related to at least one embodiment of the present disclosure. Therefore, it should be emphasized and noted that “an embodiment” or “one embodiment” or “an alternative embodiment” mentioned twice or more in different places in this specification do not necessarily mean the same embodiment. In addition, some features, structures, or characteristics in one or more embodiments of the present disclosure may be appropriately combined.

Unless otherwise defined, all terms (including technical and scientific terms) used herein have the same meaning as commonly understood by those of ordinary skill in the art to which this disclosure belongs. It will be further understood that terms, such as those defined in commonly used dictionaries, should be interpreted as having the meaning that is consistent with their meaning in the context of the relevant art and will not be interpreted in an idealized or overly formal sense unless explicitly defined herein.

The above is illustration of the present disclosure and should not be construed as making limitation thereto. Although some exemplary embodiments of the present disclosure have been described, those skilled in the art could easily understand that many modifications may be made to these exemplary embodiments without departing from the creative teaching and advantages of the present disclosure. Therefore, all such modifications are intended to be included within the scope of the present disclosure as defined by the appended claims. As will be appreciated, the above is to explain the present disclosure, it should not be constructed as limited to the specific embodiments disclosed, and modifications to the embodiments of the present disclosure and other embodiments are intended to be included in the scope of the attached claims. The present disclosure is defined by the claims and their equivalents.

What is claimed is:

1. A signal transmission method for a display device, comprising:
adjusting a data rate for signal transmission within a blanking time; and
performing signal transmission within an active time by using the data rate adjusted within the blanking time;
wherein a signal transmission period of the display device includes the blanking time and the active time.

2. The signal transmission method according to claim 1, wherein the signal transmission period is a frame period, the blanking time is a vertical blanking time,
adjusting a data rate for signal transmission within a blanking time comprises: adjusting a data rate for signal transmission within the vertical blanking time,
wherein the adjusted data rate is used for performing signal transmission within at least one frame after the vertical blanking time or used for performing signal transmission within at least one line after the vertical blanking time.

3. The signal transmission method according to claim 1, wherein the signal transmission period is a line period, the blanking time is a horizontal blanking time, and
adjusting a data rate for signal transmission within a blanking time comprises: adjusting a data rate for signal transmission within the horizontal blanking time,
wherein the adjusted data rate is used for performing signal transmission within at least one line after the horizontal blanking time.

4. The signal transmission method according to claim 3, wherein the line period has a preset time length, and a length of the active time is associated with the adjusted data rate; and
a length of the horizontal blanking time is determined by the line period and the length of the active time.

5. The signal transmission method according to claim 1, further comprising:
taking a first number of signal transmission periods as an adjustment cycle period, adjusting the data rate used for signal transmission, such that the data rate changes periodically within the adjustment cycle period,
taking a second number of signal transmission periods as a maintaining time, and performing signal transmission at the same data rate within the maintaining time,
wherein the first number and the second number are integers, and the first number is greater than the second number.

6. The signal transmission method according to claim 5, wherein
an amount of data rate change within the adjustment cycle period is less than or equal to a first threshold, and an amount of data rate change between two adjacent data rates is less than or equal to a second threshold, wherein the first threshold is greater than or equal to the second threshold.

7. The signal transmission method according to claim 6, wherein
the first threshold is 25% of a reference data rate, and the second threshold is 5% of the reference data rate.

8. The signal transmission method according to claim 5, wherein the data rate changes periodically within the adjustment cycle period comprises:
the data rate monotonically increases in a first part of the adjustment cycle period, and
the data rate monotonically decreases in a second part of the adjustment cycle period,
wherein the data rate is lower than a maximum allowable data rate at a receiving end for signal transmission.

9. The signal transmission method according to claim 8, wherein
the data rate monotonically increases in a first part of the adjustment cycle period comprises: the data rate monotonically increases at a first step size, and
the data rate monotonically decreases in a second part of the adjustment cycle period comprises: the data rate monotonically decreases at a second step size,
wherein the first step size is the same as or different from the second step size.

10. The signal transmission method according to claim 1, wherein
for a plurality of consecutive signal transmission periods of the display device, randomly determining at least one signal transmission period for adjusting the data rate for signal transmission, and
for each signal transmission period of the display device, randomly determining whether to adjust the data rate for signal transmission.

11. The signal transmission method according to claim 10, wherein, for each signal transmission period of the display device, in a case where it is determined that the data rate for signal transmission needs to be adjusted,
determining the adjusted data rate base on a current data rate according to a predetermined adjustment rule; or
determining the adjusted data rate randomly.

12. The signal transmission method according to claim 1, wherein the signal transmission method is used for a display device based on a point-to-point transmission architecture.

13. A signal transmission apparatus for a display device, comprising:
a rate adjustment circuit configured to adjust a data rate for signal transmission within a blanking time;
a signal transmission circuit configured to perform signal transmission within an active time by using the data rate adjusted within the blanking time;
wherein the signal transmission period of the display device includes the blanking time and the active time.

14. The signal transmission apparatus according to claim 13, wherein the signal transmission period is a frame period, the blanking time is a vertical blanking time, and
the rate adjustment circuit is further configured to adjust the data rate for signal transmission within the vertical blanking time,
wherein the adjusted data rate is used for performing signal transmission within at least one frame after the vertical blanking time or used for performing signal transmission within at least one line after the vertical blanking time.

15. The signal transmission apparatus according to claim 13, wherein the signal transmission period is a line period, the blanking time is a horizontal blanking time, and
the rate adjustment circuit is further configured to adjust the data rate for signal transmission within the horizontal blanking time,
wherein the adjusted data rate is used for performing signal transmission within at least one line after the horizontal blanking time.

16. The signal transmission apparatus according to claim 13, wherein
the rate adjustment circuit is further configured to
for a plurality of consecutive signal transmission periods of the display device, randomly determine at least one signal transmission period for adjusting the data rate for signal transmission; and
for each signal transmission period of the display device, randomly determine whether to adjust the data rate for signal transmission.

17. A display device that transmits a display signal through the signal transmission method according to claim 1.

18. The display device according to claim 17, wherein the display device is based on a point-to-point transmission architecture.
